(19) United States
(12) Patent Application Publication
(10) Pub. No.: US 2018/0190078 A1
(43) Pub. Date: Jul. 5, 2018

(54) GAMING DEVICE PROVIDING MULTIPLE SIMULTANEOUS CARD GAMES AND ENABLING USER TO CONTROL BETTING AMOUNT

(71) Applicant: NEXCADE CO.,LTD., Seoul (KR)

(72) Inventor: Yong Hwan KIM, Gyeonggi-do (KR)

(21) Appl. No.: 15/393,604

(22) Filed: Dec. 29, 2016

(51) Int. Cl. G07F 17/32

(52) U.S. Cl. CPC G07F 17/3293; G07F 17/3225; G07F 17/3244

(57) ABSTRACT

A gaming device providing multiple simultaneous card games and enabling a user to control a betting amount. The gaming device provides at least two simultaneous card games on a single screen with two or more betting buttons having different betting amounts, and each of the card games is configured to randomly and firstly display cards in which the betting amount thereof is selected, to receive a selection of the card to be changed or not to be changed among the firstly displayed cards, to randomly and secondly display the selected card to another card, and to allot a winning score according to a dividend rate when suits and values of the distributed cards are included in a predetermined poker hand. The present invention has an effect of enhancing interest in and enjoyment of a game because a player can play multiple card games on a single screen.

### BACKGROUND

### 1. Field of the Invention

The present invention generally relates to a card gaming device. More particularly, the present invention relates to a gaming device providing multiple simultaneous card games on a single screen and enabling a user to control of a betting amount, thus a gamer is capable of enjoying multiple card games at the same time.

### 2. Description of the Related Art

In general, a computer poker game operated on a computer of a game room or in an internet cafe is played using five cards. First, a player places a bet by selecting a betting item (Royal Flush, Straight Flush, Four of a Kind, Full House, Flush, Straight, Three of a Kind, Two Pairs, One Pair, etc.) within a betting window. Then, the game is played by sequentially dealing three left cards among five cards that are displayed on a lower part of a screen and two right cards that are among the five cards.

However, in the above poker game, game participation is decreased since the five cards are distributed by a game program and players have no choice in selecting the cards. In addition, interest or tension of the game is reduced by such features. To partially solve the above problems, a computer poker game that enables a player to select and change certain cards is provided.

This type of existing gaming device is disclosed in Korean Patent Application Publication No. 10-2008-0111296 (Computer poker game).

The computer poker game that enables a player to select a betting item within a betting window and is played by five cards including three open cards, is configured with an open card window including three opened cards; a hidden card selecting window including cards of two columns and three or more rows, and the cards thereof being moved in vertical directions by configuring virtual reels; a hidden card window; and a selecting button, wherein, by inputting the selecting button, the vertically moving cards of the hidden card selecting window are stopped and opened, and two cards of the stopped hidden card selecting window are selected as cards of the hidden card window, and a bonus is determined by using the three opened cards and the two cards of the hidden card window.

However, this kind of the existing card gaming device only allows for the playing of one game at a time. Therefore, there is no means whereby the player can play multiple games simultaneously.

To solve the above problems, multiple gaming devices are arranged by being interconnected, but in this case, different card display windows are separately operated and displayed, thus the results of each game may be different. Accordingly, players may not be satisfied with the results.

Additionally, an operator who manages card gaming devices obtains a profit depending on the amount of money user's spend using his or her device, thus effective management of space is important. However, users playing the card gaming devices tend to play games at particular times, which results in no vacant machines.

Accordingly, it is difficult for an operator to accommodate players who wish to use the card gaming devices if all the card gaming devices are fully occupied. Further, spatial constraints of the game room and investment costs also exist.

Consequently, a single card gaming device on which multiple card games can be played simultaneously is required.

The foregoing is intended merely to aid in the understanding of the background of the present invention, and is not intended to mean that the present invention falls within the purview of the related art that is already known to those skilled in the art.

### SUMMARY

To solve the above problem, an aspect of the present invention is to provide a gaming device providing multiple simultaneous card games and enabling a user to control a betting amount, whereby a player can play multiple card games simultaneously.

Another aspect of the present invention is to provide a gaming device providing multiple simultaneous card games and enabling a user to control a betting amount, whereby a player can play multiple card games at the same time since the card gaming device can display at least two card display games on a single screen.

A further aspect of the present invention is to provide a gaming device providing multiple simultaneous card games and enabling a user to control a betting amount, whereby the gaming device can simultaneously operate multiple card games and allot a winning score according cards displayed in each card game.

Yet another aspect of the present invention is to provide a gaming device providing multiple simultaneous card games and enabling a user to control a betting amount, whereby the gaming device simultaneously distributes cards to a game that is selected by a player as well as cards of games that are not selected by the player among multiple card games displayed on a screen by simultaneously spinning virtual reels on which the cards are located and by simultaneously stopping the reels after a predetermined time.

To solve the above problem, an aspect of the present invention is to provide a gaming device providing multiple card games and enabling a user to control a betting amount, whereby at least one poker hand is set in the card gaming device, the card gaming device including: at least two card games displayed on a single screen, each of the card game including a card display window displaying four or more cards having one or more suits and values in a row, and a betting button configured with two or more buttons displaying betting amounts, the betting buttons being configured to enable the user to respectively select the betting amount of the card games; and a controller determining that a corresponding betting amount of the card game is selected when the betting button thereof is once input by the user, randomly and firstly distributing cards to the card display window in which the betting amount is selected when the game is started, receiving a selection from the user the card to be changed or not to be changed among the firstly distributed cards, randomly and secondly distributing a card to the card to be changed or not to be changed that is selected among the firstly distributed cards, and allotting a winning score according to a dividend rate when the distributed cards of each card display window are included in the predetermined poker hand.

The controller may differently display the card display window with the betting amount being selected and the card display window without the betting amount being selected. The betting button, except for the selected betting button, may be displayed as a non-selected button. The betting buttons may be provided with a betting button displaying “0”.

The betting button displaying “0” may be displayed as the same as the selected betting button when the betting button displaying “0” is selected. The controller may determine that the betting has been input when the betting button thereof having the maximum amount is selected by the user.

In addition, the gaming device may further include a start button, and the betting amount of each card game may be determined by an immediately preceding selected betting button thereof before the start button is input. The controller may sequentially or simultaneously, and randomly distribute the cards to the card display window with the betting amount being selected when the start button is input.

Accordingly, a gaming device providing multiple simultaneous card games on a single screen and enabling a user to control a betting amount according to one embodiment of the present invention has an effect of enhancing interest in and enjoyment of a game because a player can play multiple card games simultaneously.

Also, in a gaming device providing multiple simultaneous card games on a single screen and enabling a user to control a betting according to one embodiment of the present invention, a player can play multiple card games in a small room. Therefore, a game room can be more effectively managed.

In addition, as the present invention displays multiple simultaneous card games on a single screen and a winning result of a card game that is not selected by a player is also displayed, and thus the player may feel that the game is fairly played.

### BRIEF DESCRIPTION OF THE DRAWINGS

The above and other aspects, features and other advantages of the present invention will be more clearly understood from the following detailed description when taken in conjunction with the accompanying drawings, in which:

FIG. 1 is a main configuration diagram of a gaming device providing multiple simultaneous card games on a single screen and enabling a user to control a betting amount according to an embodiment of the present invention;

FIGS. 2 to 4 are view showing examples of screen configurations according to an embodiment of the present invention;

FIG. 5 is a view showing an example of betting buttons;

FIG. 6 is a view showing examples of poker hands;

FIG. 7 is a view showing an example of a comparison screen of a card display window for which a betting amount is selected and a card display window for which a betting amount is not selected; and

FIG. 8 is a flow chart explaining a method of controlling a gaming device providing multiple simultaneous card games and enabling a user to control a betting amount according to an embodiment of the present invention.

### DETAILED DESCRIPTION

All terms or words used herein should not be interpreted as being limited merely to common and dictionary meanings but should be interpreted as having meanings and concepts which are defined within the technical scope of the present invention.

Unless the context clearly indicates otherwise, it will be further understood that the terms “comprises”, “comprising”, “includes”, and/or “including” when used herein, specify the presence of stated features, integers, steps, operations, elements, and/or components, but do not preclude the presence or addition of one or more other features, integers, steps, operations, elements, components, and/or groups thereof. Also, the terms “˜ part”, “˜ unit”, “module”, “apparatus” and the like mean a unit for processing at least one function or operation and may be implemented by a combination of hardware and/or software.

An embodiment of the present invention will be hereinafter described with reference to the accompanying drawings.

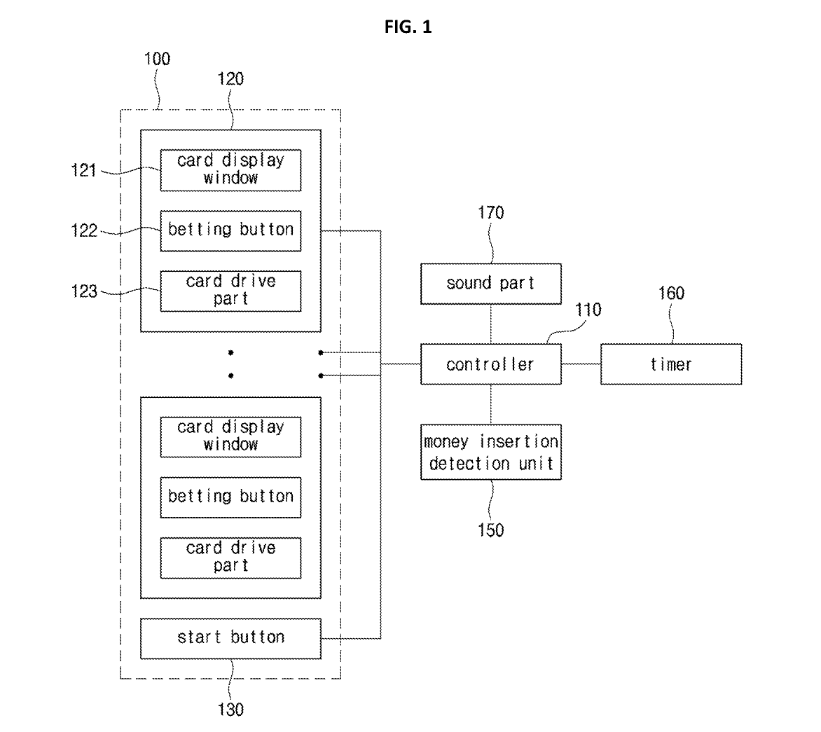

FIG. 1 is a main configuration diagram of a gaming device providing multiple card games and enabling a user to control a betting amount according to an embodiment of the present invention. As shown in FIG. 1, the card gaming device of the present invention is configured on a single screen including at least two individual card games 120 and a controller 110 controlling the at least two card games 120.

It is one feature of the present invention that at least two individual card games 120 and a controller 110 capable of simultaneously controlling the at least two card games 120 such that a single player can play multiple card games simultaneously is provided.

To implement the above description, the individual card games 120 include card display windows 121, wherein each of the card games includes a card display window 121 displaying four or more cards having one or more suits and values in a row, betting buttons 122; a card drive part 123 for driving the card display window 121.

The card display window 121 may be configured to play the corresponding card game by displaying various cards. In the present invention, for convenience of explanation, the card display window 121 with 1×5 cards, that is, one row and five columns is used.

At least two card games 120 including card display windows 121 are configured to be displayed on a single screen 100.

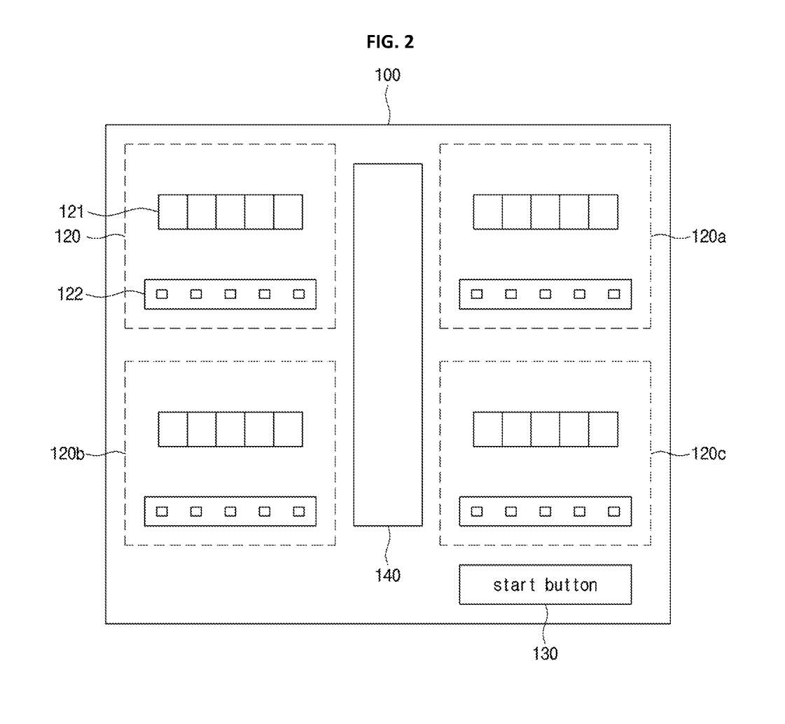

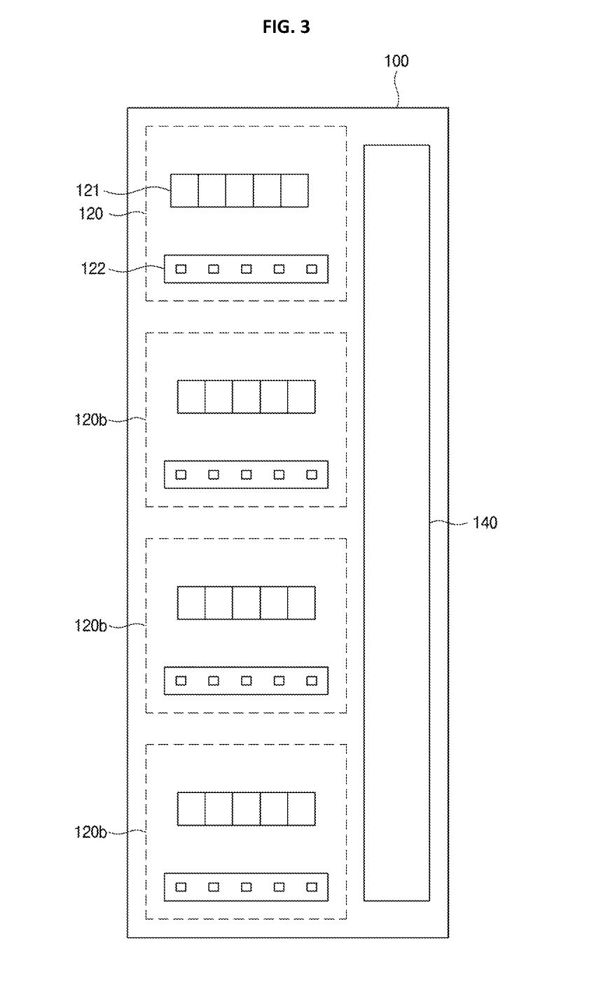

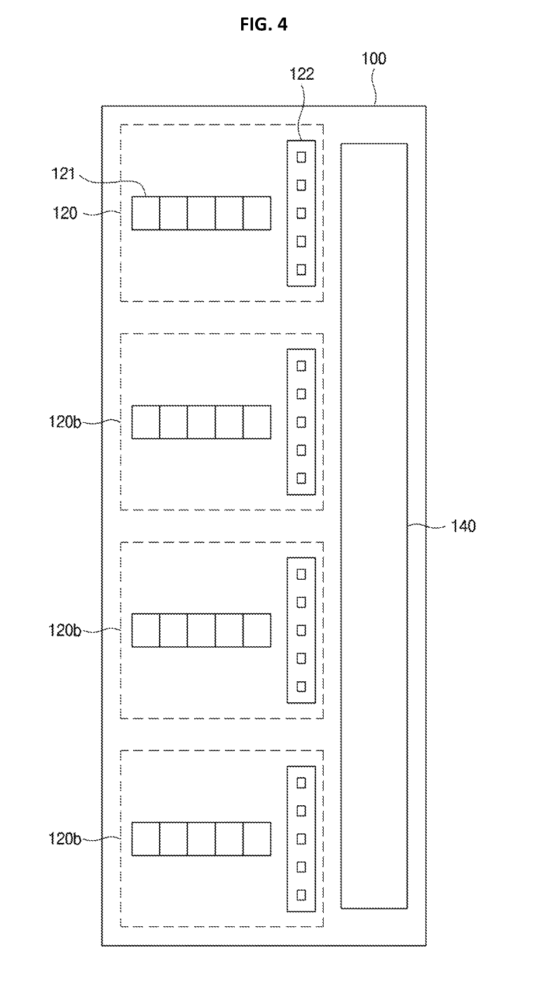

Referring to FIG. 2 showing an example of a screen configuration diagram according to the embodiment of the present invention, four card games 120 including card display windows 121 are displayed on the single screen 100, the card display windows 121 are respectively provided with betting buttons 122 on one side of the card display window 121. In FIG. 2, the betting buttons 122 are located in a lower part of the card display window 121.

In addition, the card display window 121 may display images or text that is necessary for a game. In the embodiment of the present invention, cards with 52 values and suits are used and the card display window 121 is configured with 1*5 (row*column) cards. The cards are variably displayed by an operation of the card drive part 123.

The betting buttons 122 include betting buttons displaying different betting amounts such that a user is capable of selecting the betting amount.

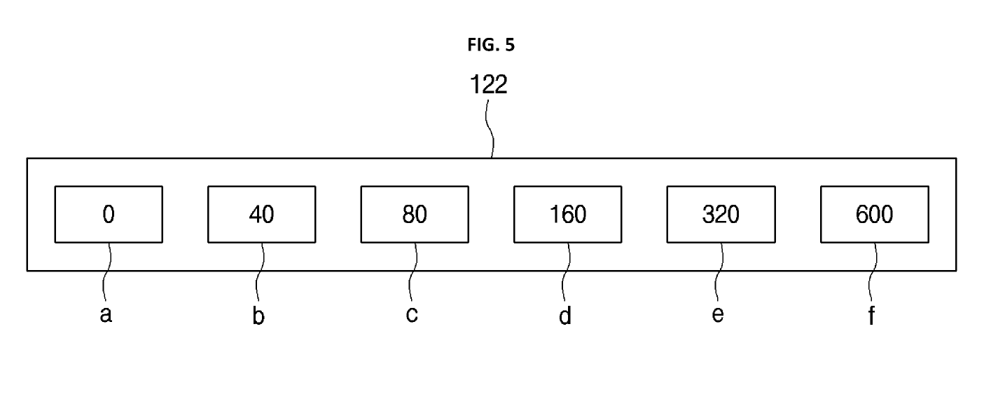

Referring to FIG. 5 showing an example of the betting buttons, the betting buttons 122 are configured with betting buttons displaying different betting amounts.

In one embodiment, the betting buttons 122 may be provided with differing betting amounts of “0”, “40”, “80”, “160”, “320”, and “600”.

In addition, a selected betting button and non-selected betting buttons are differently displayed.

In other words, the betting buttons 122, except for the selected betting button, are displayed as non-selected buttons. The betting button is turned on or turned off by turning on or off a lamp when the betting button is selected.

The betting button 122 is activated by turning on the lamp. Accordingly, the betting buttons 122 that are not turned on are considered deactivated.

The betting buttons 122 are provided in a lower part of each card display window 121 such that the user is capable of easily selecting a betting amount for each card display window 121.

In addition, the betting buttons 122 include deactivation buttons. When the deactivation button is selected, the controller 110 determines that the corresponding card display window 121 as a card display window 121 without a betting amount.

Herein, all betting buttons 122 of the corresponding card display window 121 except for the deactivation button are turned off such that the player is aware that the betting amount is not selected.

When the player has input a betting amount in a previous or in a current game and does not want to bet any more, the user may select the deactivation button to make the betting amount of the corresponding card display window 121 be “0”. Thus, the corresponding card display window 121 is handled not to be played.

Referring to FIG. 5, a betting button displaying “0” is used as deactivation button, when the betting button 122 displaying “0” is input, the betting button displaying “0” is turned on or off as the same as the selected betting button described above by turning a lamp on or off.

In other words, when the betting button displaying “0” is input, the corresponding betting button is activated the same as the betting button in which a betting amount is determined. The controller 110 differently displays the card display window 121 in which the betting button displaying “0” is selected and suits of the card display window 121 in which the betting button is not selected or is selected are displayed differently by varying contrast or color thereof until a start button 130 of the card gaming device is input.

The betting button displaying “0” is activated such that the player is clear that the betting amount of the corresponding card display window 121 is “0”.

In addition, the betting amount of the card display window 121 is determined by selecting one of the betting buttons.

The determined betting amount is canceled when the selected betting button has been selected once again or another betting button is selected.

In other words, when the betting amount is selected in a previous game or in a current game, the selected betting amount is canceled by inputting the selected betting button once again.

In addition, the betting amount may be increased by repeatedly pressing the betting button and the betting amount that is increased by the number of times the betting button has been pressed may be displayed in the card display window 121.

Alternatively, when the betting amount is selected, the selected betting amount is canceled by inputting another betting button.

For example, when the betting button displaying “40” is selected, the betting amount is set to “40”; however, the set betting amount “40” is canceled by selecting the betting button 122 displaying “40” once again. Alternatively, when the betting button displaying “80” is selected after selecting the betting button 122 displaying “40”, the set betting amount “40” is canceled and is replaced to “80”.

In addition, for example, when the betting button displaying “40” is selected and the corresponding betting butting button is selected once more, then the betting amount may be increased by “80”, the betting amount may be increased and by “120” by selecting the betting button once again.

Preferably, when the betting button displaying a corresponding betting amount is input, the selected betting button may be turned on to display that the corresponding betting amount is set (refer to activating), and the corresponding betting amount may be canceled by inputting the selected betting button once again (refer to deactivating).

Herein, all betting buttons of the betting buttons 122 may be operated as the deactivation button.

In addition, the controller 110 determines as the betting amount the amount of the betting button 122 that is finally selected before the start button 130 is input.

In other words, when the betting amount is set and the corresponding betting button 122 is turned on in a current game and the player inputs another betting button 122, the new input betting button 122 is turned on and the previous selected betting button 122 is turned off, and the betting amount of the new betting button 122 that is finally input is set as the betting amount.

Herein, “finally” means the last selected betting button 122 before inputting a start button 130 when the start button 130 is provided.

In addition, the controller 110 may simultaneously and randomly distribute cards to the card display window 121 with the betting amount being selected when a start button 130 is input, by simultaneously spinning virtual reels on which the cards are located and by simultaneously stopping the reels after a predetermined time.

A money insertion detection unit 150 uses a well-known sensor for detecting insertion of coins or tokens through a coin slot, or a well-known note sensing device for detecting insertion of bills or scrip money through a paper money slot or a card reader.

A timer 160 displays a remaining betting time or a progress of the remaining betting time as a graph.

A sound part 170 is controlled to output some rhythmical music with the progress of the game. Also, the sound part 170 makes sound effect when a jackpot score is displayed or when a bonus game is played.

Additionally, to add visual effect, a lamp outputting various colors of light may be installed and operated.

When the betting amount is selected through the betting buttons 122, the controller 110 distributes the cards to the card display window 121 with the betting amount being selected and the card display window 121 without the betting amount being selected by simultaneously spinning virtual reels on which the cards of the card display window 121 are located and simultaneously stopping the reels after a predetermined time, and allots a winning score according to a dividend rate when values and suits of the distributed cards of the card display window 121 with the betting amount being selected are determined to be included in a predetermined poker hand.

Alternatively, when the betting amount is selected through the betting buttons 122, the controller 110 may distribute the cards to the card display window 121 with the betting amount being selected and the card display window 121 without the betting amount being selected by sequentially spinning virtual reels on which the cards are located and by sequentially stopping the reels after a predetermined time.

For example, the controller 110 may sequentially distribute the cards to the card display windows 121 in a descending order of betting amount, in an ascending order of betting amount, or in a random order and sequentially stop in a distribution order.

Alternatively, the controller 110 may display the card display window 121 without the betting amount being selected in a stopped state until the card distribution of the card display window 121 with the betting amount being selected is completed.

Herein, the card display window 121 without the betting amount being selected may be differently displayed than the card display window 121 with the betting amount being selected by displaying the window in monochrome or in different color.

The controller 110 may play the card game 120 with conventional poker hands.

Poker hands may be set as follows by combining suits and values of five cards that are displayed in the card display window 121.

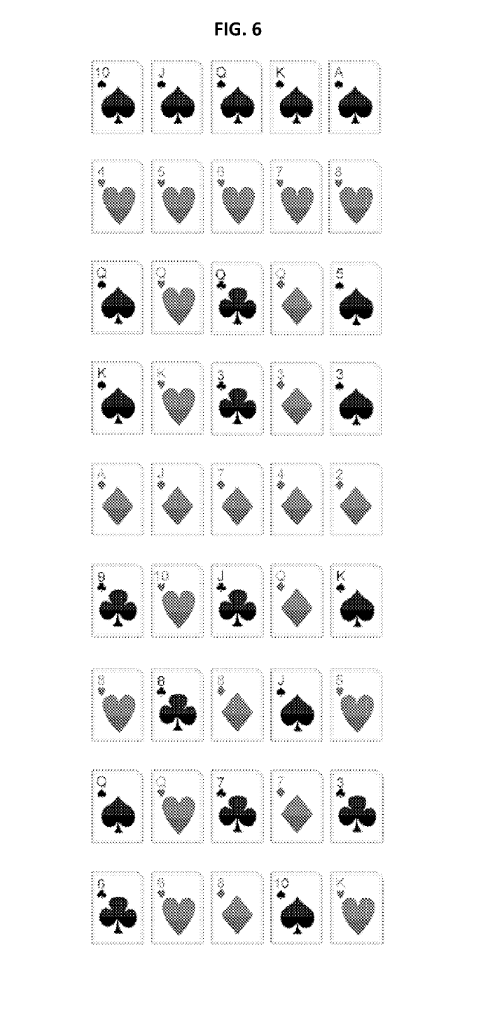

Referring to FIG. 6 showing examples of poker hands, a “Royal Straight Flush” that is placed in the top stage refers to cards whereby suits of five cards are all identical and values thereof are 10, J, Q, K, A.

A “Straight Flush” refers to cards whereby suits of five cards are all identical and values thereof are in sequence.

A “Four of a Kind” refers to cards whereby values of 4 cards are identical, and a “Full House” refers to cards whereby values of three cards (triple) are identical and the values of the remaining two cards (one pair) are identical.

A “Flush” refers to cards whereby suits of five cards are identical, and the sixth stage refers to a “Mountain” refers to cards whereby values of five cards are 10, J, Q, K, A, but suit thereof are different.

A “Straight” refers to cards whereby values of five cards are in sequence regardless of suits thereof, a “Triple” refers to cards whereby values of three cards are identical, and a “Two pair” refers to cards whereby two pairs of identical values are included in the cards. A “One pair” refers to cards whereby values of two cards are identical.

In addition, when identical poker hands come out, the poker hand with higher number wins the game.

For example, a player with two pairs of two's and five's defeats a player with two pairs of three's and four's.

For reference, values of cards are determined in the following order.
2<3<4< . . . <10<J<Q<K<A

In addition, when players get identical poker hands with the same values, for example, a one-pair of heart three's (♥ 3) and a one-pair of spade three's ( [symbol] 3), then the player with higher value in the remaining cards wins the game.

In addition, a selected winning line is displayed in one side of the screen 100 such that the player may easily check the selected winning line.

For example, the bonus display window 140 may display the poker hands.

Additionally, the betting units 122 may further include an automatic button. Accordingly, the player does not input the start button 130 for every game but the game may be started automatically when a start condition is satisfied.

These functions may be added as a matter of convenience, therefore a detailed description thereof is omitted.

By control of the controller 110, the card drive part 123 spins the cards of the card display window 121 at the same time and simultaneously stops them after a predetermined time has passed.

When a combination of suits and values of the card display window 121 driven by the card drive part 123 is included in the predetermined poker hand, the controller 110 may display a winning score according to a dividend rate on a winning score display window.

In addition, when the controller 110 determines that the user has completed the betting through the betting buttons 122, the controller 110 distributes the cards to the card display windows 121 by simultaneously spinning virtual reels on which the cards are located and simultaneously stopping the reels after a predetermined time has passed by controlling the card drive parts 123, allots a winning score according to a dividend rate when values and suits of the stopped cards of each the card display window 121 are determined to be included in a poker hand, and displays the winning score on the winning score display window.

The controller 110 determines that the betting has been completed when all the betting amounts are selected through the betting buttons (a-f) of the betting buttons 122 for the individual card game 120, when the start button 130 is input, or when the betting time that is displayed on the individual timer 160 or on the timer 130 has finished. Then, the controller 110 randomly distributes cards of the card display windows 121 by simultaneously controlling the card drive part 123 of each card display window 121.

The bonus display window 140 is configured to displays a bonus score and play a bonus game when the game result of the individual card game 120 corresponds to the bonus game.

The controller 110 receives an output signal from the money insertion detection unit 150 and the betting buttons 122, and controls the operations of the timer 160, the card drive part 123, the winning score display window, the sound part 170, and the bonus display window 140 while performing a card game.

In other words, when the controller 110 determines that the user has completed the betting through the betting buttons 122, the controller 110 simultaneously distributes the cards of the card display windows 121 by simultaneously spinning virtual reels on which the cards are located and simultaneously stopping the reels after the predetermined time, allots the winning score according to the dividend rate when the values and suits of the distributed cards of the card display windows 121 are determined to be included in the predetermined poker hand, and displays the winning score on the winning score display window.

The controller 110 determines that the betting has been completed when all the betting amounts are selected through the betting buttons (a˜f) of the betting buttons 122 for the individual card game 120, when the start button 130 is input, or when the betting time that is displayed on the timer 160 has finished. When betting has been completed, the controller 110 simultaneously drives the card drive parts 123 for the individual card game 120 to randomly distribute the cards to the card display windows 121.

Herein, the controller 110 differently displays the card display window 121 with the betting amount being selected with the card display window 121 without the betting amount being selected.

In addition, the start button 130 may be provided on one side of the screen 100 as shown in FIG. 2. When the start button 130 is placed on the screen 100, a user may have a slight impact on his or her finger, thus the impact may lead to a pain since gamers on average play three or more hours and enjoy 100 or more card games per hour. Therefore, it is preferable to provide the start button 130 on one side of the card gaming device, not on the screen 100.

In addition, the card display window 121 with the betting amount being selected and the card display window 121 without the betting amount being selected are differently displayed such that the player may easily recognize it.

In other words, the card display window 121 without the betting amount being selected may be displayed in monochrome, or may be displayed having a different color compared with the card display window 121 with the betting amount being selected.

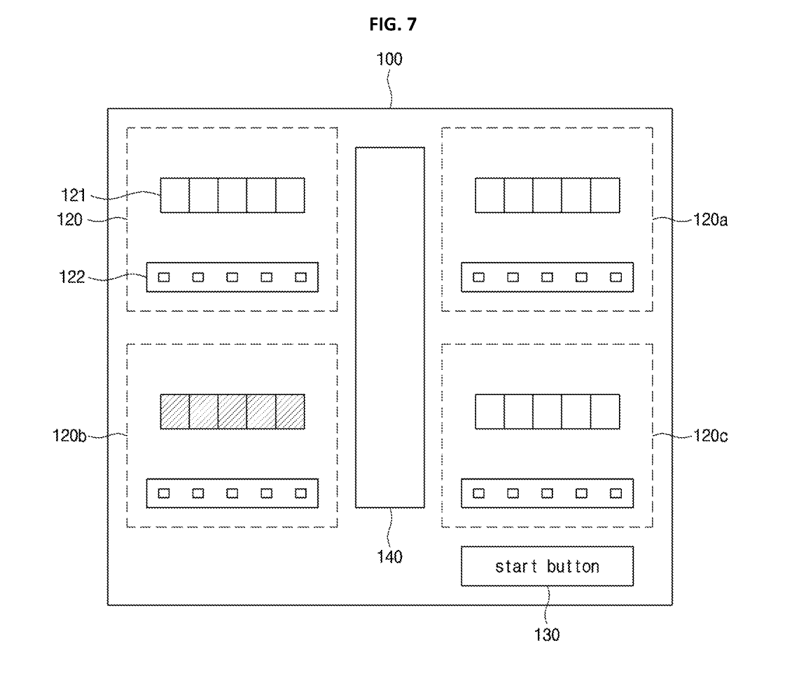

In one embodiment, referring to FIG. 7 showing an example of a comparison screen of a card display window 121 with a betting amount being selected and a card display window 121 without a betting amount being selected, the card display window 121 without the betting amount being selected is span and displayed in monochrome.

In FIG. 7, monochrome suits are expressed by diagonal lines.

In addition, when values and suits of the cards of the card display window 121 without the betting amount being selected are determined to be included in the predetermined poker hand, the controller 110 turns on the corresponding card display window 121 such that the player may recognize it.

Also, when values and suits of the distributed cards of the card display window 121 are the same as predetermined suits and values that are set to lead to a bonus game or a jackpot, the controller 110 may play a bonus game and allot a bonus score, display a jackpot score and allot the jackpot score, or play a jackpot game.

An administrator or the player may select one among the playing of the bonus game, the allotment of the jackpot score, or the play of the jackpot game.

The bonus display window 140 displays the playing of the bonus game and the bonus score on one side of the screen 100. The jackpot score and the playing of the jackpot game may be displayed on the individual card display windows 121, but may be also displayed in bonus display window 140.

Herein, when the jackpot game is played, the controller 110 makes sound effect through the sound part 170 in order to notify the user of the winning or the start of the jackpot game.

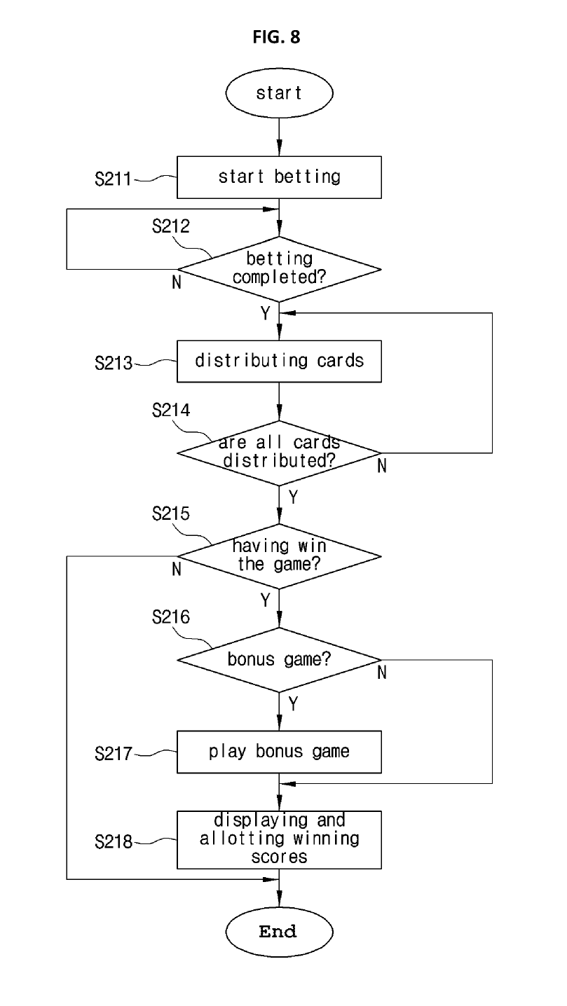

FIG. 8 is a flow chart explaining a method of controlling a gaming device providing multiple simultaneous card games on a single screen and enabling a user to control a betting amount according to an embodiment of the present invention. As shown in the figure, in step S211, a betting amount for each card game 120 is selected through the betting buttons 122 by a user; in step S212, the controller 110 determines whether the betting has been completed and in step S213, the controller 110 distributes cards to the card display windows 121 at the same time when the controller 110 determines that the betting has been completed in step S212, and in step S214, the controller 110 determines whether the distribution of the cards are completed.

In the steps S213 and S214, the controller 110 may simultaneously distribute the cards to the card display window 121 with the betting amount being selected and the card display window 121 without the betting amount being selected, or may sequentially distribute the cards to the card display window 121 with the betting amount being selected, or may display the card display window 121 without the betting amount being selected in a stopped state until the card distribution of the card display window 121 with the betting amount being selected is completed.

After distributing the cards in the step S214, in step S215, the controller 110 determines whether values and suits of the cards distributed in the card display window 121 are included in predetermined poker hands. In step S218, the controller 110 allots a winning score for each card display window 121 according to a dividend rate when the values and suits of the distributed cards of the card display window 121 are included in the predetermined poker hands.

In more detail, in step S210, the controller 110 may display a betting time when the controller 110 determines that credit is inserted through the money insertion detection unit 110.

Herein, the controller 110 displays the remaining betting time or the progress of the remaining betting time as a graph in the timer 160 such that the user visually checks the betting progress status.

Also, at step S211, the user bets by selecting the betting amount.

The betting amount is selected by using the betting buttons (a˜f). Accordingly, when the betting button is selected, the corresponding displayed credit of the betting button is selected.

At step S212, the controller 110 determines whether the betting has been completed for each card game 120, through the betting buttons 122. The controller 110 determines that the betting is completed when betting amounts of all card games 120 are selected through the betting buttons (a˜f) of the betting button 122, as described above, when the start button 130 is selected, or when the betting time displayed in the timer 160 has finished.

In addition, the controller 110 may determine that the corresponding card game is bet when the betting button thereof having the maximum amount is selected by the user.

In step S213, when the controller 110 determines that the betting has been completed at step S212, the controller 110 simultaneously outputs control signals for driving the card drive parts 123 of the individual card games 120, so as to distribute the cards of the card display windows 121.

When the cards for each of the individual card games 120 are distributed in step S213, in step S214, the controller 110 stops the distribution of the cards for each the individual card games 120 by transmitting control signals for simultaneously stopping distribution of the cards for each of the individual card games 120 to the card drive parts 123 of the individual card games 120.

In step S213, the controller 110 may randomly and firstly distribute cards to the card display window 121 in which the betting amount is selected, receive a selection from the user the card to be changed or not to be changed among the firstly distributed cards, and randomly and secondly distribute a card to the card to be changed or not to be changed that is selected among the firstly distributed cards.

Herein, the game result may be displayed in each card display windows 121.

When the distribution of the cards for each of the card games 120 are completed in step S214, in steps S216 and S217, the controller 110 plays a bonus game according to the distributed cards, or in step S218, the controller 110 allots the winning score and ends the game.

Alternatively, when the controller 110 determines that the values and suits of the cards distributed in the card display window 121 are not included in predetermined poker hands in step S215, the controller 110 plays the next game or ends the card game. Alternatively, in step S216, the controller 110 determines whether or not to play a bonus game.

As described above, when the suits and values of the distributed cards of the card display windows 121 are the same as the suits that are set to lead to a bonus game, the bonus game is played.

When a condition for the bonus game is satisfied at step S216, in step S17, the bonus game is played. Then, in step S218, as the result of the bonus game, a winning score is displayed and allotted.

However, when the condition for the bonus game is not satisfied at step S216, in step S218, the controller 110 displays the winning score according to the betting amount of the user and allots the winning score

As the results of the games may be differently displayed for the individual card games 120, it is preferable to play the bonus game in each card display windows 121.

Herein, the winning scores for individual card games 120 are respectively displayed on the card display windows 121.

As described above, the present invention is configured to provide at least two card games in a single screen and to operate the card games at the same time. Accordingly, a player can enjoy multiple card games simultaneously, thus improving space occupancy.

In addition, the present invention provides at least two card display games to stimulate player enjoyment of the game by interconnecting the games on one screen, or to allow play of an individual game on one screen.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A gaming device providing multiple card games and enabling a user to control a betting amount, whereby at least one poker hand is set in the card gaming device, the card gaming device comprising:
at least two card games displayed on a single screen, each of the card game including a card display window displaying four or more cards having one or more suits and values in a row, and a betting button configured with two or more buttons displaying betting amounts, the betting buttons being configured to enable the user to respectively select the betting amount of the card games; and
a controller determining that a corresponding betting amount of the card game is selected when the betting button thereof is once input by the user, randomly and firstly distributing cards to the card display window in which the betting amount is selected when the game is started, receiving a selection from the user the card to be changed or not to be changed among the firstly distributed cards, randomly and secondly distributing a card to the card to be changed or not to be changed that is selected among the firstly distributed cards, and allotting a winning score according to a dividend rate when the distributed cards of each card display window are included in the predetermined poker hand.

2. The gaming device of claim 1, wherein the controller differently displays the card display window with the betting amount being selected and the card display window without the betting amount being selected.

3. The gaming device of claim 1, wherein the betting button, except for the selected betting button, is displayed as a non-selected button.

4. The gaming device of claim 3, wherein the betting buttons are provided with a betting button displaying “0”.

5. The gaming device of claim 4, wherein the betting button displaying “0” is displayed as the same as the selected betting button when the betting button displaying “0” is selected.

6. The gaming device of claim 1, wherein the controller determines that the betting has been input when the betting button thereof having the maximum amount is selected by the user.

7. The gaming device of claim 1, further comprising a start button, wherein the betting amount of each card game is determined by an immediately preceding selected betting button thereof before the start button is input.

8. The gaming device of claim 1, further comprising: a start button, and wherein the controller sequentially or simultaneously, and randomly distributes the cards to the card display window with the betting amount being selected when the start button is input.

9. The gaming device of claim 1, wherein the controller distributes the cards to the card display window without the betting amount being selected when distributing the cards to the card display window with the betting amount being selected, or displays the card display window without the betting amount being selected in a non-distributed state until the card distribution of the card display window with the betting amount being selected is completed.

10. The gaming device of claim 9, wherein the controller displays the card display window without the betting amount being selected in an active or in an inactive state until the card distribution of the card display window with the betting amount being selected is completed.

11. The gaming device of claim 10, wherein the controller allots a total winning score by adding the winning score according to the dividend rate when the distributed cards of each card display window are included in the poker hand.
